(19) United States
(12) Patent Application Publication
(10) Pub. No.: US 2009/0145426 A1
(43) Pub. Date: Jun. 11, 2009

(54) REFINED SUGAR MANUFACTURING PROCESS

(76) Inventor: Fernando Cesar Boscariol, Sao Paulo (BR)

Correspondence Address: DICKINSON WRIGHT PLLC, 1875 Eye Street, NW, Suite 1200, WASHINGTON, DC, 20006, US

(21) Appl. No.: 11/719,758

(22) PCT Filed: Nov. 22, 2005
(86) PCT No.: PCT/BR05/00239

§ 371 Date: May 21, 2007

(30) Foreign Application Priority Data
Nov. 24, 2004 (BR) PI0405323-0

(51) Int. Cl. C13F 1/02; C13F 1/06

(52) U.S. Cl. 127/46.2; 127/58

(57) ABSTRACT

“PROCESS OF DIRECT REFINED SUGAR PRODUCTION”, being a process that uses the sugar syrup as raw material to produce granulated refined sugar, characterized by changing the conventional process of non-refinated sugar production by the addition of three modules designated as clarification, decoloration and new cooking process that, together with the conventional plant, allow the production of refined sugar, and there is not necessity of crystallized sugar dissolution, followed by its recrystallization.

The present descriptive report refers to the invention patent of the developed process of refined sugar production, as its designation attempts to say, in order to allow the production of refined sugar directly from the sugar syrup, without the necessity of dissolution and posterior sugar recrystallization.

The technique status comprises a productive process in which the raw material used to produce refined sugar is the crystallized sugar in its several types, such as the white crystallized sugar, VHP, VVHP, demerara, and others.

In the process of the production of crystallized sugar in its several forms designated above, the sugar cane, after it is received in the industrial plant, is chopped and defibrated, passing then by an assemblage of grinders for extraction of the juice rich in sugars. From the assemblage of grinders, two product streams come out: the pomace (fibrous residue from the sugar cane), that is sent to the furnaces to thermal energy generation, and the mixed juice, rich in saccharosis, other sugars and impurities, that is destined to its clarification and purification system.

In the clarification system, this mixed juice is heated, passes by a sulphitation process with sulphur and lime, with the calcium hydroxide being sent then to the clarifiers (decanters), where the impurities and the clarified juice are separated.

Then this clarified juice is concentrated from its original concentration (13-17 brix degrees) up to a concentration of 60-65 brix degrees, when then it passes to be designated as syrup. This concentration is performed in an equipment named multiple effect evaporators, that use the thermal energy contained in the vapor and the pressure and temperature differences between their several bodies to concentrate the juice in a more efficient manner.

This concentrated juice, now designated as syrup, is then sent to the sugar cooking sector, where the saccharosis crystallization is done in an equipment named cooking voids. After this step, the sugar mass is then sent to the sugar centrifuges, where, by the centrifuge forge, the saccharosis crystals are separated from the honey that involves them. The honey is returned to the process for the residual sugar that is still found in the same be crystallized again, and the sugar is sent to the drying, where its humidity is lowered from 1.0-1.5% up to 0.04-0.08%, and posterior chilling, where its temperature is reduced up to 37-40 Celsius degrees.

This obtained sugar is the named white crystallized sugar, and it will serve as raw material for the conventional process of refined sugar obtention.

In the conventional productive process, the sugar is dissolved in one or more dissolvers, an equipment designed to this specific purpose.

In the dissolver, the sugar is mixed to heated water is is subjected to agitation, up to the formation of the sugar juice in the desired concentration. Next, this juice is pumped to a filtration system, in a manner to eliminate a portion of the impurities and, after, it is pumped to a decoloration system.

The decoloration can be performed by several known processes, such as phosflotation, ionic change, use of charcoal or a combination of these processes, pending of the desired quality in the final product.

In the phosflotation, phosphoric acid is added to the sugar juice that, posteriorly, is neutralized with hydrated lime. A decolorant and a flocculent are also added to the mixture. Next, the juice is heated by a heat changer, is aerated inside a specific equipment for such function and, next, is pumped to the flotator, where it is separated in two phases, being one lighter, constituted by flakes that retain the impurities, and other more dense, the flotated juice.

The flotated juice is subjected to a filtration in sand filters, and can be: subjected to a complimentary decoloration by means of ionic change resins or charcoal filters, being posteriorly pumped to the sugar crystallization and drying sector.

In the crystallization sector, this clarified juice is concentrated in an equipment known as cooking voids up to its supersaturation point, when then a certain amount of powdered sugar is added, and that will serve as seed for the cooking.

The cooking is extended until the point where the crystals attain the right size and the cooking void is completely full. The product is then discharged in tanks known as crystallizers and, next, it is pumped to the centrifuges, that take charge of promoting the separation among the honey, that returns to the beginning of the process or in subsequent cookings, until its exhaustion point, and the saccharosis crystals, that are sent to drying and chilling.

Inside the dryer-chiller, the saccharosis crystals are in contact with dry hot air, reducing their relative humidity up to levels of 0.04-0.05%, being posteriorly chilled until the temperature of, at maximum, 40° C. for their sacking and storage.

The product is packed in 1-kg, 2-kg, 5-kg, 50-kg sacks or in 1200-kg big-bags, according to the market to which it is destined.

One of the drawbacks of the conventional process refers to the high cost of the production plant fixtures, by including the sugar dissolution and recrystallization steps, that also contribute to increase the product production cost due to the extra energy consumption.

One of the objectives of this Invention Patent resides in providing a new solution for the refined sugar production, in a manner to reduce its production cost, as well as the initial investments needed in the productive plant construction.

Thus, in order to allow a better elucidation of the process in question, it will be performed its detailed description referring to the following drawings, where:

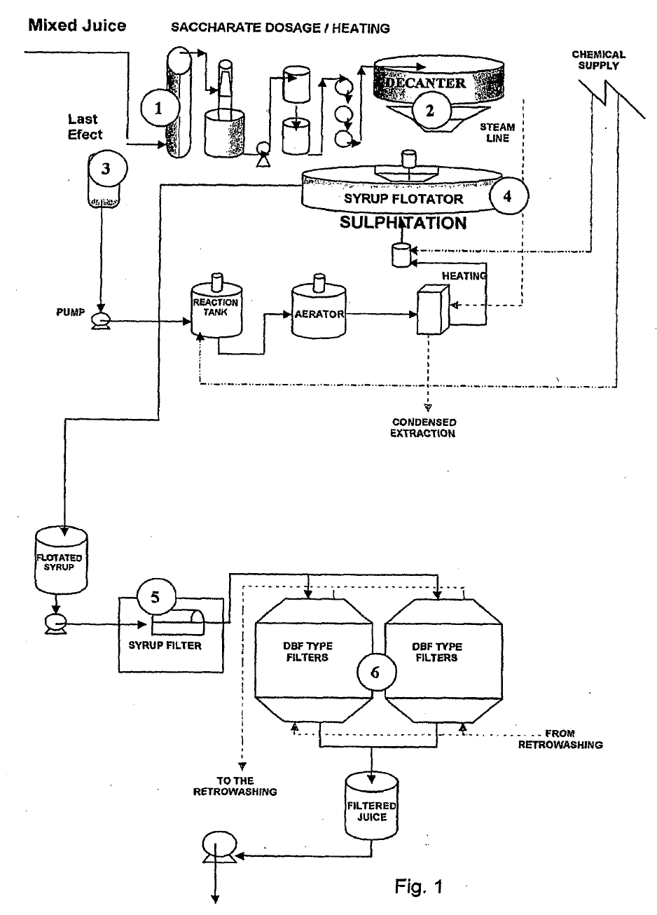

the FIG. 1 illustrates the syrup clarification system;

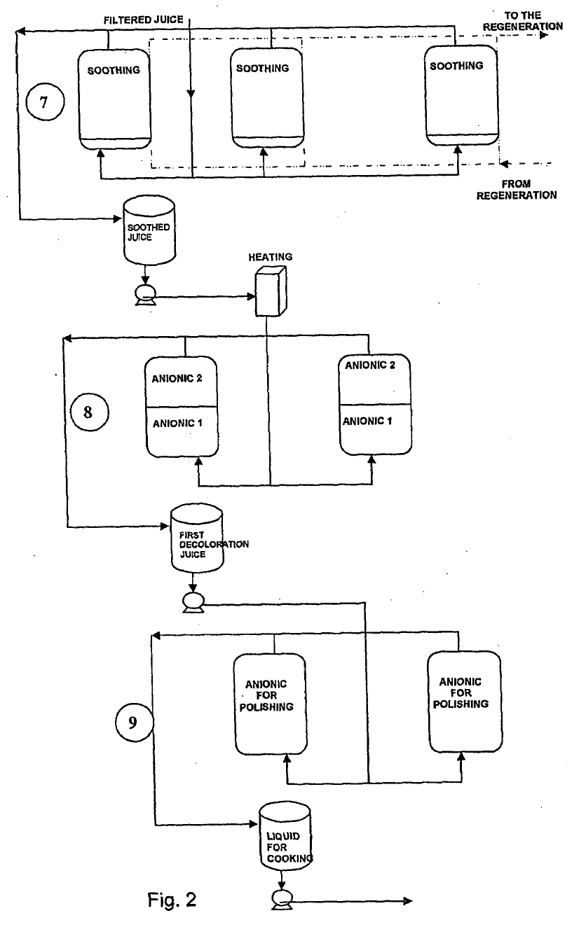

the FIG. 2 illustrates the three steps of the syrup decoloration system by ionic change;

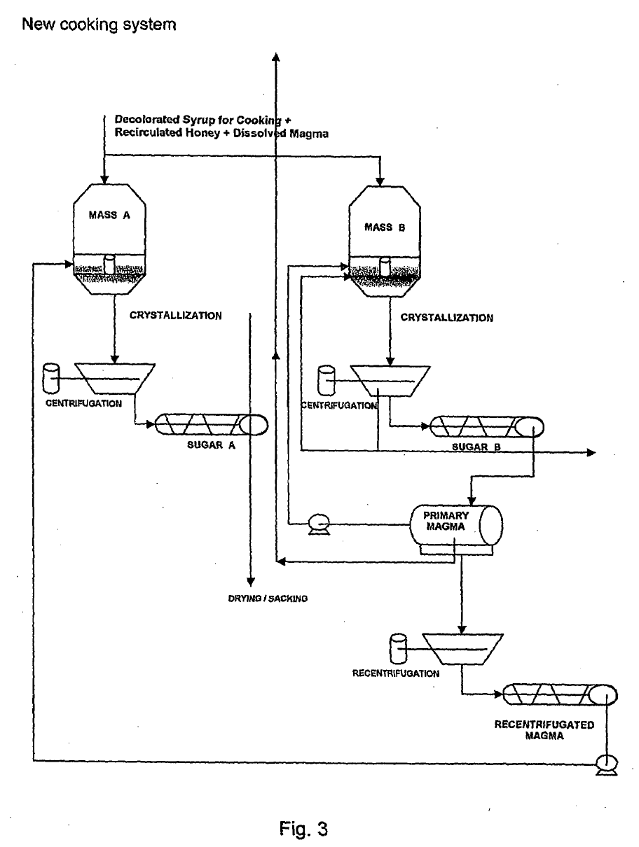

the FIG. 3 illustrates the cooking system;

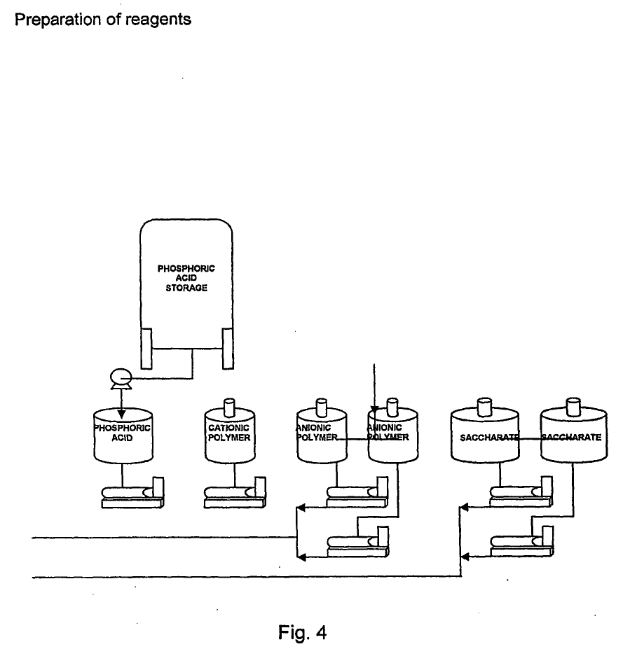

the FIG. 4 illustrates the chemical preparation and dosage process;

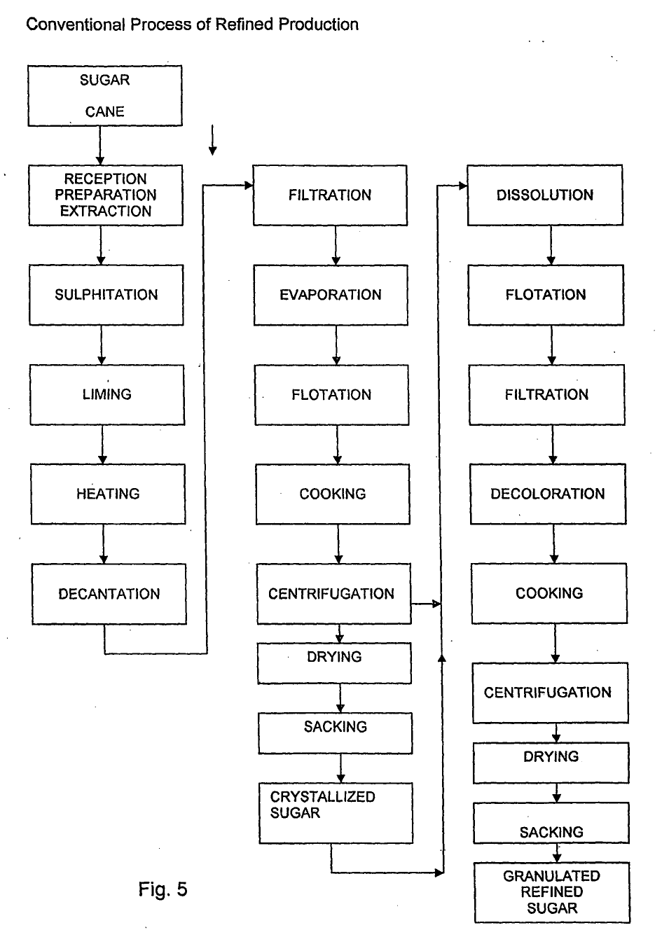

the FIG. 5 illustrates the composition in modules of the conventional process;

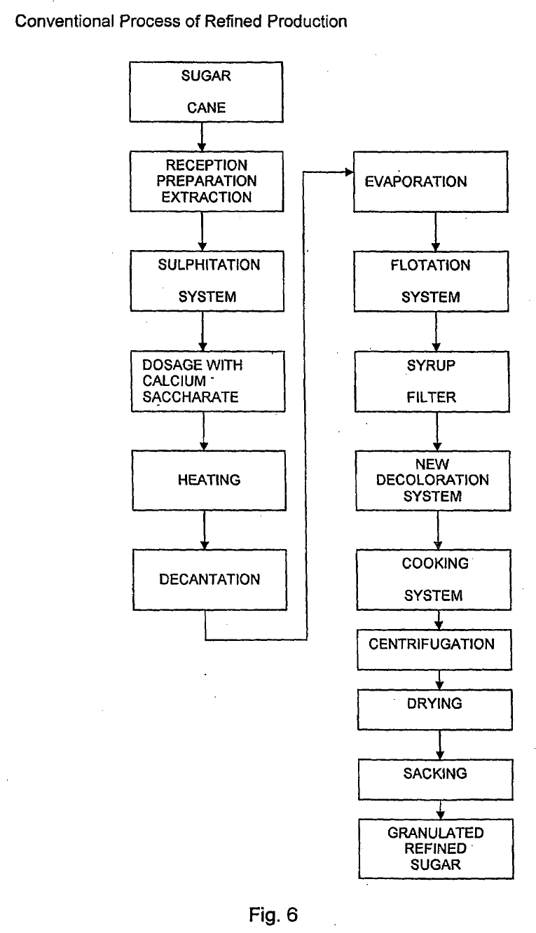

the FIG. 6 illustrates the composition in modules of the new proposed process;

In accordance with what the above mentioned figures illustrate, the process of direct refined sugar production, object of this Invention Patent, comprises a process in which the raw material used to produce granulated refined sugar is the syrup, and there is not necessity of dissolution followed by the sugar recrystallization.

During the sugar cane processing, the juice rich in saccharosis is extracted, in a concentration of total soluble solids that goes from 13% to 17%. After the heating, this juice is clarified by means of a sulphitation (Item 1 from the FIG. 1) and decantation (Item 2 from the FIG. 1) process.

After the clarification, the juice is destined to multiple effect evaporators, where its concentration is elevated to levels to 60 to 65 brix degrees, constituting the designated sugar syrup.

After leaving the designated last effect evaporator (Item 3 from the FIG. 1), the sugar syrup begins its flotation process, where phosphoric acid, cationic decolorant, calcium saccharate and a flocculant agent are used.

By leaving from the flotator (Item 4 from the FIG. 1), the syrup is pumped to the filter (Item 5 from the FIG. 1) for impurity remotion. The syrup passes by the deep bed filters (Item 6 from the FIG. 1), that use special sands for filtration, and by the decoloration system by ionic change, that uses ionic changer columns (Items 7, 8 and 9 from the FIG. 2), where synthetic resins specially designed for the syrup decoloration are used.

The ionic change system is composed by three steps: soothing or demineralization (Item 7 from the FIG. 2), decoloration (Item 8 from the FIG. 2) and polishing or complimentary decoloration (Item 8 from the FIG. 2).

The syrup, after being soothed and decolorated, is destined to the sugar crystallization sector, where it will be subjected to a new cooking system (FIG. 3) that operates with two cooked masses with distinct purity. In the first mass (A), the raw material to be used is composed, in part, by the magma obtained from the second cooking mass (B) and by the alimentation with a high purity solution that can be obtained by dissolution of the primary magma, or not, in the instance of the proper purity levels have been already achieved, and with the previously flotated and decolorated syrup.

For the functioning of this new cooking system, the use of additional equipment such as a continuous centrifuge, additional crystallizers, dissolver and process pumps becomes necessary. The flow of the products and their amounts in this new cooking system can be changed according to the conditions of the raw material to be used, in other words, if there is necessity, there can be a more intense recentrifugation or not, a dissolution of a portion of the magma in the proper amount for process conduction or total sending of the same to the recentrifugation and modification of the proportions of decolorated syrup, dissolved solutions and honey recirculation; these are among the possible options to be adopted in this new system.

After the cooking, crystallization and centrifugation, the sugar is sent to the dryer, where the saccharosis crystals are in contact with dry hot air, reducing their relative humidity until levels between 0.03% and 0.05%, being posteriorly chilled until the temperature of, at maximum, 40° C. for its sacking and storage in the conventional manner.

1. “PROCESS OF DIRECT REFINED SUGAR PRODUCTION”, characterized by a process that uses the sugar syrup as raw material to produce granulated refined sugar, and there is not the necessity of the crystallized sugar dissolution, followed by its recrystallization.

2. “PROCESS OF DIRECT REFINED SUGAR PRODUCTION”, according to the claim 1, characterized by changing the conventional process of non-refined sugar production by the addition of three modules denominated clarification, decoloration and new cooking process that, together with the existing plant, allow the granulated refined sugar, without the recrystallization necessity.

3. “PROCESS OF DIRECT REFINED SUGAR PRODUCTION”, according to the claim 1, characterized by a composed clarification process by a sulphitation system (Item 1 from the FIG. 01), endowed with columns and/or multiple ejectors, preparation and dosage system with calcium saccharate and juice decanters (Item 2 from the FIG. 01) with minor retention time, properly designed to hasten the decantation process and to improve the quality of the clarified juice destined to the evaporation system.

4. “PROCESS OF DIRECT REFINED SUGAR PRODUCTION”, according to the claim 1, characterized by a purification process of the sugary solutions obtained from the sugar cane, in which the sugar syrup, after leaving the last effect of the evaporation system (Item 3 from the FIG. 1), goes to the flotation process, where phosphoric acid, cationic decolorant, calcium saccharate and a flocculant agent are used.

5. “PROCESS OF DIRECT REFINED SUGAR PRODUCTION”, according to the claim 1, characterized by a decoloration process in which the sugar syrup, by leaving from the flotator (Item 4 from the FIG. 1), is pumped to the filter (Item 5 from the FIG. 1), that can use the centrifuge force and/or pressure differential to the impurity remotion, posteriorly passes by the deep bed filters (Item 6 from the FIG. 1), that use filtration media specified to this purpose and by the decoloration system by ionic change, that uses ionic interchange columns (Items 7, 8 and 9 from the FIG. 2) where synthetic resins designed for the syrup decoloration are used.

6. “PROCESS OF DIRECT REFINED SUGAR PRODUCTION”, according to the claim 5, characterized by a decoloration process by ionic change composed by three steps known as soothing or demineralization (Item 7 from the FIG. 2), decoloration (Item 8 from the FIG. 2) and polishing or complimentary decoloration (Item 9 from the FIG. 2).

7. “PROCESS OF DIRECT REFINED SUGAR PRODUCTION”, according to the claim 1, characterized by a cooking process (FIG. 3) that uses continuous centrifuges, additional crystallizers, dissolver and process pumps, in which the sugar syrup, after being soothed and decolorated, is destined to the sugar crystallization sector, where it will be subjected to a cooking system that operates with two cooked masses with distinct purities, being that, in the mass A, the raw material to be used is composed, in part, by the magma (partially dissolved sugar) obtained from the second cooking line (mass B) and/or by the recirculation of this same dissolved magma, subjected to double centrifugation and redissolution or not, centrifugation's honey recirculation, according to the process necessity, together with the treated and decolorated syrup, forming a high purity solution, that will feed the first line cookings (mass A), that after being centrifuged will originate the granulated refined sugar.

8. “PROCESS OF DIRECT REFINED SUGAR PRODUCTION”, according to the claim 1, characterized by a drying process, where the saccharosis crystals are in contact with dry hot air, reducing their relative humidity until levels between 0.03% and 0.05%, being posteriorly chilled until the temperature of, at maximum, 40° C. for their sacking and storage in the conventional form.
